(19) United States
(12) Patent Application Publication
(10) Pub. No.: US 2012/0129052 A1
(43) Pub. Date: May 24, 2012

(54) COMPOSITE MATERIAL CONTAINING A MIXED LITHIUM-METAL OXIDE

(75) Inventors: Peter Bauer, Buch Am Erlbach (DE); Nicolas Tran, Nandlstadt (DE); Christian Vogler, Moosburg (DE)

(73) Assignee: SUD-CHEMIE AG, MUNCHEN (DE)

(21) Appl. No.: 13/319,918

(22) PCT Filed: May 10, 2010
(86) PCT No.: PCT/EP10/56358

§ 371 Date: Feb. 8, 2012

(30) Foreign Application Priority Data
May 11, 2009 (DE) 10 2009 020 832.1

(51) Int. Cl. H01M 4/131; H01M 4/485; B82Y 30/00

(52) U.S. Cl. 429/231.1; 252/182.1; 977/742; 977/734

(57) ABSTRACT

A composite material containing particles, in part provided with a pyrocarbon coating, of a mixed lithium metal oxide, as well as particles, in part provided with a pyrocarbon layer, of elementary carbon. Also, a process for producing such a composite material as well as an electrode containing the composite material and a secondary lithium-ion battery containing an electrode comprising the composite material.

### CROSS REFERENCE TO RELATED APPLICATIONS

This application is the U.S. National Phase Application of PCT/EP2010/056358, filed May 10, 2010, which claims priority to German Patent Application No. 10 2009 020 832.1, filed May 11, 2009, the contents of such applications being incorporated by reference herein.

### FIELD OF THE INVENTION

The present invention relates to a composite material containing particles, which are in part coated with pyrocarbon, of a mixed lithium metal oxide, as well as particles, which are likewise in part coated with pyrocarbon, of elementary carbon. The present invention further relates to a process for producing such a composite material and its use in electrodes of secondary lithium-ion batteries.

Doped and non-doped mixed lithium metal oxides have recently received attention in particular as electrode materials in so-called “lithium-ion batteries”.

For example, non-doped or doped mixed lithium transition metal phosphates have been used as cathode material, in particular as cathode material in electrodes of secondary lithium-ion batteries, since papers from Goodenough et al. (U.S. Pat. No. 5,910,382), which is incorporated by reference. To produce the lithium transition metal phosphates, both solid-state syntheses and also so-called hydrothermal syntheses from aqueous solution are proposed. Meanwhile, almost all metal and transition metal cations are known from the state of the art as doping cations.

### BACKGROUND OF THE INVENTION

Thus WO 02/099913, which is incorporated by reference describes a process for producing LiMPO₄, wherein M, in addition to iron, is (are) one or more transition metal cation(s) of the first transition metal series of the periodic table of the elements, in order to produce phase-pure optionally doped LiMPO₄.

EP 1 195 838 A2, which is incorporated by reference describes the production of lithium-transition metal phosphates, in particular LiFePO₄, by means of a solid-state process, wherein typically lithium phosphate and iron (II) phosphate are mixed and sintered at temperatures of approximately 600° C.

Further processes for producing in particular lithium iron phosphate have been described for example in Journal of Power Sources 119 to 121 (2003) 247 to 251, JP 2002-151082 which is incorporated by reference A as well as in DE 103 53 266, which is incorporated by reference.

Conductive carbon black is usually added to the thus-obtained doped or non-doped lithium transition metal phosphate and processed to cathode formulations. Thus EP 1 193 784, which is incorporated by reference, EP 1 193 785, which is incorporated by reference as well as EP 1 193 786, which is incorporated by reference describe so-called carbon composite materials of LiFePO₄ and amorphous carbon which, when producing iron phosphate from iron sulphate, sodium hydrogen phosphate also serves as reductant for residual Fe³⁺ radicals in the iron sulphate as well as to prevent the oxidation of Fe²⁺ to Fe³⁺. The addition of carbon is also intended to increase the conductivity of the lithium iron phosphate active material in the cathode. Thus in particular EP 1 193 786, which is incorporated by reference, indicates that not less than 3 wt.-% carbon must be contained in the lithium iron phosphate carbon composite material in order to achieve the necessary capacity and corresponding cycle characteristics of the material.

EP 1 049 182, which is incorporated by reference, proposes to solve similar problems by coating lithium iron phosphate with amorphous carbon.

A current overview of anode materials in so-called lithium-ion batteries is found e.g. in: Bruce et al., Angew. Chem. Int. Ed. 2008, 47, 2930-2946, which is incorporated by reference.

The use of doped and non-doped lithium titanates, in particular lithium titanate Li₄Ti₅O₁₂ (lithium titanium spinel)in rechargeable lithium-ion batteries has been described for some time as a substitute for graphite as anode material.

The advantages of Li₄Ti₅O₁₂ compared with graphite are in particular its better cycle stability, its better thermal load capacity and higher operational reliability. Li₄Ti₅O12 has a relatively constant potential difference of 1.55 V compared with lithium and achieves several 1000 charge/discharge cycles with a loss of capacity of <20%.

Thus lithium titanate has a clearly more positive potential than graphite which has previously customarily been used as anode in rechargeable lithium-ion batteries.

However, the higher potential also results in a lower voltage difference. Together with a reduced capacity of 175 mAh/g compared with 372 mAh/g (theoretical value) of graphite, this leads to a clearly lower energy density compared with lithium-ion batteries with graphite anodes.

However, Li₄Ti₅O12 has a long life and is non-toxic and is therefore also not to be classified as posing a threat to the environment.

As already said above, LiFePO₄ has recently been used as cathode material in lithium-ion batteries, with the result that a voltage difference of 2 V can be achieved in a combination of Li₄Ti₅O12 and LiFePO₄.

Various aspects of the production of lithium titanate Li₄Ti₅O12 are described in detail. Usually, Li₄Ti₅O₁₂ is obtained by means of a solid-state reaction between a titanium compound, typically TiO₂, and a lithium compound, typically Li₂CO₃, at high temperatures of over 750° C. (U.S. Pat. No. 5,545,468), which is incorporated by reference. This high-temperature calcining step appears to be necessary in order to obtain relatively pure, satisfactorily crystallizable Li₄Ti₅O₁₂, but this brings with it the disadvantage that excessively coarse primary particles are obtained and a partial fusion of the material occurs. The thus-obtained product must therefore be ground extensively, which leads to further impurities. Typically, the high temperatures also often give rise to by-products, such as rutile or residues of anatase, which remain in the product (EP 1 722 439 A1), which is incorporated by reference.

Sol-gel processes for producing Li₄Ti₅O12 are also described (DE 103 19 464 A1), which is incorporated by reference. In these, organotitanium compounds, such as for example titanium tetraisopropoxide or titanium tetrabutoxide, are reacted in anhydrous media with for example lithium acetate or lithium ethoxide to produce Li₄Ti₅O₁₂. However, the sol-gel methods require the use of titanium starting compounds that are far more expensive than TiO₂ and the titanium content of which is lower than in TiO₂, with the result that producing lithium titanium spinel by means of the sol-gel method is usually uneconomical, in particular as the product still has to be calcined after the sol-gel reaction in order to achieve crystallinity.

Production processes by means of flame spray pyrolysis are also proposed (Ernst, F. O. et al. Materials Chemistry and Physics 2007, 101(2-3) pp. 372-378), which is incorporated by reference as well as so-called “hydrothermal processes” in anhydrous media (Kalbac, M. et al., Journal of Solid State Electrochemistry 2003, 8(1) pp. 2-6), which is incorporated by reference.

Further possibilities for producing lithium titanate, in particular by means of solid-state processes, are described for example in US 2007/0202036 A1, which is incorporated by reference as well as U.S. Pat. No. 6,645,673, which is incorporated by reference, but they have the disadvantages already described above, namely that impurities such as for example rutile or residues of anatase are present, as well as further intermediate products of the solid-state reaction such as Li₂TiO₃ etc.

Furthermore, in addition to producing non-doped Li₄Ti₅O12, the production and properties of Al-, Ga- and Co-doped Li₄Ti₅O₁₂ have also been described (S. Huang et al. J. Power Sources 165 (2007), pp. 408-412), which is incorporated by reference.

However, high requirements apply for the rechargeable lithium-ion batteries provided for use today in particular also in cars, in particular in relation to their discharge cycles as well as their capacity. However, the materials or material mixtures proposed thus far have yet to achieve the required electrode density, as they do not display the required compressed powder density. The compressed density of the material can be correlated approximately to the electrode density or the density of the so-called active material as well as the battery capacity. The higher the compressed density, the higher also the capacity of the battery.

### DESCRIPTION OF THE INVENTION

Therefore, An object of the present invention was to provide an improved electrode material for secondary lithium-ion batteries which has in particular an improved compressed density compared with the materials of the state of the art.

An object of the present invention is achieved by a composite material containing particles, in parts provided with a pyrocarbon coating, of a mixed lithium metal oxide, and particles, in parts provided with a pyrocarbon layer, of elementary carbon.

Surprisingly the composite material according to aspects of the invention has compressed densities which, compared with the usual electrode materials of the state of the art, display an improvement of at least 10%.

By increasing the compressed density, a higher electrode density is thus also achieved, with the result that the capacity of the battery is also increased approx. by a factor of 5% using the composite material according to aspects of the invention as active material in the cathode and/or in the anode of a secondary lithium-ion battery.

By a mixed lithium metal oxide is meant here compounds which, in addition to lithium and oxygen, also contain at least one further main- or sub-group metal. This term thus also includes compounds such as phosphates with the generic formula LiMPO₄, vanadates with the generic formula LiMVO₄, corresponding plumbates, molybdates and niobates. In addition, “classic oxides”, such as mixed lithium transition metal oxides of the generic formula LiₓM_{y}O (0≦x,y≦1), are also understood by this term, wherein M is preferably a so-called “early transition metal” such as Ti, Zr or Sc, but may also albeit less preferably be a “late transition metal” such as Co, Ni, Mn, Fe, Cr.

The term “elementary carbon” means here that particles of pure carbon which may be both amorphous and also crystalline but form discrete particles (in the form of spheres, such as e.g. spherical graphite, flakes, grains etc.), can be used. Examples of amorphous carbon are e.g. Ketjenblack, acetylene black, carbon black etc. However, within the framework of the present invention a crystalline elementary carbon allotrope is quite particularly preferably used. Examples of this are graphite, carbon nanotubes as well as the class of compounds of fullerenes and mixtures thereof. Also, the so-called VGCF carbon (vapour grown carbon fibres) is just as preferred as the crystalline allotropes.

The term “pyrocarbon” denotes an uninterrupted, continuous layer of non-crystalline carbon which has no discrete carbon particles. The pyrocarbon is obtained by heating, i.e. pyrolysis of precursor compounds at temperatures of below 1500° C., preferably below 1200° C. and more preferably of below 1000° C. and most preferably of below 800° C. At higher temperatures of in particular >1000° C. an agglomeration of the particles on the mixed lithium metal oxides due to so-called “fusion” often occurs, which typically leads to a poor current-carrying capacity of the composite material according to aspects of the invention. Important here is only that no crystalline ordered synthetic graphite forms, the production of which requires temperatures of at least 2800° C. at normal pressure.

Typical precursor compounds are for example carbohydrates such as lactose, sucrose, glucose, polymers such as for example polystyrene butadiene block copolymers, polyethylene, polypropylene, aromatic compounds such as benzene, anthracene, toluene, perylene as well as all other compounds known as suitable per se for the purpose to a person skilled in the art.

The exact temperature also depends on the specific mixed lithium metal oxide to be coated, as e.g. lithium transition metal phosphates often already break down into phosphides at temperatures around 800° C., whereas “classic” lithium metal oxides can even often be heated to up to 2000° C. without breaking down.

In preferred embodiments of the present invention the mixed lithium metal oxide of the composite material according to aspects of the invention is a lithium transition metal phosphate.

The term “a lithium transition metal phosphate” means within the framework of this invention that the lithium transition metal phosphate is present both doped or non-doped.

“Non-doped” means that pure, in particular phase-pure transition metal phosphate is used. The transition metal is preferably selected from the group consisting of Fe, Co, Mn or Ni or mixtures thereof, thus has the formulae LiFePO₄, LiCoPO₄, LiMnPO₄ or LiNiPO₄.

By a doped lithium transition metal phosphate is meant a compound of the formula LiM′_{y}M″ₓPO₄, wherein M″=Fe, Co, Ni or is Ni, M′ is different from M″ and represents at least a metal cation from the group consisting of Co, Ni, Mn, Fe, Nb, Ti, Ru, Zr, B, Mg, Ca, Cu, Cr or combinations thereof, but preferably represents Co, Ni, Mn, Fe, Ti, B, Mg and Nb, x is a number <1 and >0.01 and y is a number >0.001 and <0.99. Typical preferred compounds are e.g. LiNb_{y}FeₓPO₄, LiMg_{y}FeₓPO₄ LiB_{y}FeₓPO₄ LiMn_{y}FeₓPO₄, LiCo_{y}FeₓPO₄, LiMn_{z}Co_{y}FeₓPO₄ with 0≦x, y, z≦1)

In yet further preferred embodiments of the present invention the mixed lithium metal oxide of the composite material according to aspects of the invention is a lithium titanium oxide.

By “a lithium titanium oxide” are understood here all doped or non-doped lithium-titanium spinels (so-called “lithium titanates”) of the type Li₁₊ₓTi₂₋ₓO₄ with 0≦x≦1/of the spatial group Fd3m and generally also all mixed lithium titanium oxides of the generic formula LiₓTi_{y}O (0≦x,y≦1).

As already stated above, in preferred developments the mixed lithium titanium oxide used in the composite material according to aspects of the invention is doped with at least one further metal, which leads to an increased stability and cycle stability when using the doped lithium titanium oxide as anode. In particular, this is achieved by the incorporation of additional metal ions, more preferably Al, B, Mg, Ga, Fe, Co, Sc, Y, Mn, Ni, Cr, V, Sb, Bi or several of these ions, into the lattice structure.

The doped and non-doped lithium titanium spinels are preferably rutile-free.

In all the above-named mixed lithium metal oxides the doping metal ions are present preferably in a quantity of from 0.05 to 3 wt.-%, preferably 1-3 wt.-%, relative to the total mixed lithium metal oxide. The doping metal cations occupy either the lattice positions of the metal or of the lithium. Exception to this are mixed Fe, Co, Mn, Ni mixed phosphates which contain at least two of the above-named elements, in which larger quantities of doping metal cations may also be present, in the extreme case up to 50 wt.-%.

With a monomodal particle-size distribution, the D₁₀ value of the composite material is preferably ≦0.19, the D₅₀ value preferably ≦0.43 and the D₉₀ value ≦2.15 μm.

As already said a small particle size of the composite material according to aspects of the invention leads, when used as electrode in a battery, to a higher current density and also to a better cycle stability. Of course, the composite material according to aspects of the invention can also be ground even more finely, should this be necessary for a specific use. The grinding procedure is carried out with methods known per se to a person skilled in the art.

The layer thickness of the pyrocarbon coating is advantageously 2-15, preferably 3-10 and quite particularly preferably 5-7 nm, wherein the layer thickness can be set selectively in particular by the starting concentration of precursor material, the exact choice of temperature and duration of the heating.

In particularly preferred embodiments of the present invention the pyrocarbon coating is located on the whole surface both of the mixed lithium metal oxide particles and of the elementary carbon particles. The formation of the polycarbon layer on the elementary carbon particles can be detected for example by TEM (transmission electron microscopy) methods.

In quite particularly preferred embodiments the BET surface area according to DIN 66134 of the mixed lithium metal oxide is ≦20 m²/g, quite particularly preferably ≦15 m²/g and most preferably ≦12 m²/g. Small BET surface areas have the advantage that the compressed density and thus the electrode density, consequently also the capacity of a battery, is increased.

Surprisingly, despite the at least partial coating of the mixed lithium metal oxide particles with pyrocarbon, which would suggest a greater BET surface area and thus a small compressed density, the composite material according to aspects of the invention has a high compressed density of ≦2.0 g/cm³, preferably in the range of from 2.0 to 3.3 g/cm³, yet more preferably in the range of from 2.2 to 2.7 g/cm³. This compressed density results in clearly greater electrode densities in an electrode containing the composite material according to aspects of the invention than the materials of the state of the art, with the result that the capacity of a battery also increases when using such an electrode.

The powder resistance of the composite material according to aspects of the invention is preferably <35 Ω/cm, quite particularly preferably <33 Ω/cm, even more preferably <30 □□cm, whereby a battery containing such an electrode is also characterized by a particularly high current-carrying capacity.

The entire carbon content of the composite material according to aspects of the invention (thus the sum of pyrocarbon and the elementary carbon particles) is preferably <3 wt.-% relative to the total mass of composite material, even more preferably <2.5 wt.-%.

In further preferred embodiments the total carbon content is approximately 2.2±0.2 wt.-%. The ratios of elementary carbon to pyrocarbon lie in a range of from 3:1 to 1:3. Quite particularly preferably the ratio is 1:1, with the result that with a total carbon content of 2.2 wt.-%, it is more preferably 50%, i.e. 1.1±0.1 wt.-% relative to the total mass of composite material from the elementary carbon particles and the remainder of the total carbon, thus 1.1±0.1 wt.-% from the pyrocarbon coating, both on the mixed lithium metal oxide particles and on the elementary carbon particles.

An object of the present invention is further achieved by a process for producing a composite material according to aspects of the invention, comprising the steps of
a) providing particles of a lithium metal oxide
b) adding a precursor compound for pyrocarbon and elementary carbon particles to form a mixture
c) compacting the mixture from step b)
d) heating the compacted mixture.

As already stated above, the mixed lithium metal oxide for use in the process according to aspects of the invention may be present both doped and also non-doped. All the mixed lithium metal oxides described in more detail above can be used in the present process.

According to aspects of the invention it is unimportant how the synthesis of the mixed lithium metal oxide has been carried out before use in the process according to aspects of the invention. In other words the mixed lithium metal oxide can be obtained both within the framework of a solid-state synthesis or also within the framework of a so-called hydrothermal synthesis, or also via any other process.

However, it was shown that mixed lithium metal oxide, in particular a lithium transition metal phosphate, which was obtained by a hydrothermal route, is particularly preferably used in the process according to aspects of the invention and in the composite material according to aspects of the invention, as this often contains fewer impurities than one obtained by solid-state synthesis.

As already mentioned above almost all organic compounds which can be converted to carbon under the reaction conditions of the process according to aspects of the invention are suitable as precursor compounds for pyrocarbon.

In particular carbohydrates, such as lactose, sucrose, glucose or mixtures thereof, quite particularly preferably lactose, polymers such as for example polystyrene butadiene block copolymers, polyethylene, polypropylene, aromatic compounds such as benzene, anthracene, toluene, perylene as well as mixtures thereof and all compounds known as suitable per se for the purpose to a person skilled in the art, are preferred within the framework of the process according to aspects of the invention.

When using carbohydrates, these are used, in preferred embodiments, in the form of an aqueous solution, or in an advantageous development of the present invention, water is then added after mixing the carbon with the mixed lithium metal oxide and/or the elementary carbon, with the result that a slurry is obtained, the further processing of which is preferred in particular from production engineering and emission points of view compared with other process variants.

Other precursor materials such as for example benzene, toluene, naphthalene, polyethylene, polypropylene etc. can be used either directly as pure substance or in an organic solvent.

Typically, within the framework of the process according to aspects of the invention, a slurry is formed which is then dried before carrying out the compacting at a temperature of from 100 to 400° C.

The compacting of the dry mixture itself can take place as mechanical compaction e.g. by means of a roll compactor or a tablet press, but can also take place as rolling, build-up or wet granulation or by means of any other technical method appearing suitable for the purpose to a person skilled in the art.

After compacting the mixture from step b), in particular the dried mixture, the mixture is quite particularly preferably sintered at ≦800° C., even more preferably at ≦750° C., as already stated above in detail, wherein the sintering takes place preferably under protective gas atmosphere. Under the chosen conditions no graphite for pyrocarbon results from the precursor compounds, but a continuous layer of pyrocarbon which partly or completely covers the particles from the mixed lithium metal oxide and the elementary carbon.

Although pyrocarbon still forms from the precursor compound over a wide temperature range at higher temperatures during sintering, the particle size in particular of the particles from the mixed lithium metal oxide increases through caking, which brings with it the disadvantages described above.

Nitrogen is used as protective gas for production engineering reasons, during the sintering or pyrolysis, but all other known protective gases such as for example argon etc., as well as mixtures thereof, may be used. Technical-grade nitrogen with low oxygen contents can equally also be used. After heating, the obtained product is then finely ground in order to then find use as a starting product for producing an electrode.

An object of the present invention is further achieved by an electrode for a secondary lithium-ion battery containing the composite material according to aspects of the invention as active material. A higher electrode active material density in the electrode after formulation is also achieved because of the increased compressed density of the composite material according to aspects of the invention. Typical further constituents of an electrode are, in addition to the active material, conductive carbon blacks and a binder. Any binder known per se to a person skilled in the art may be used as binder, such as for example polytetrafluoroethylene (PTFE), polyvinylidene difluoride (PVDF), polyvinylidene difluoride hexafluoropropylene copolymers (PVDF-HFP), ethylene-propylene-diene terpolymers (EPDM), tetrafluoroethylene hexafluoropropylene copolymers, polyethylene oxides (PEO), polyacrylonitriles (PAN), polyacryl methacrylates (PMMA), carboxymethylcelluloses (CMC), and derivatives and mixtures thereof.

Within the framework of the present invention typical proportions of the individual constituents of the electrode material are preferably 80 to 90 parts by weight active material, i.e. of the composite material according to aspects of the invention, 10 to 5 parts by weight conductive carbon and 10 to 5 parts by weight binder.

Because of the composite material according to aspects of the invention, which already contains carbon, in particular in the present case the quantity of conductive carbon in the formulation of the electrode can also be clearly reduced compared with the electrodes of the state of the art.

The electrode according to aspects of the invention typically has a compressed density of >1.5 g/cm³, preferably >2.0 g/cm³, particularly preferably >2.2 g/cm³. The specific capacity of an electrode according to aspects of the invention is approx. 150 mA/g at a volumetric capacity of >200 mAh/cm³, more preferably >225 mAh/cm³.

Depending on the nature of the mixed lithium metal oxide, the electrode functions either as anode (preferably in the case of doped or non-doped lithium titanium oxide, which certainly can be used in less preferred embodiments, again depending on the nature of counterelectrode, as cathode) or as cathode (preferably in the case of doped or non-doped lithium transition metal phosphate).

An object of the present invention is further achieved by a secondary lithium-ion battery containing an electrode according to aspects of the invention as cathode or as anode, with the result that a battery with higher electrode density (or density of active material) is obtained having a higher capacity than previously known secondary lithium-ion batteries, whereby the use of such lithium-ion batteries, in particular in cars with simultaneously smaller measurements of the electrode or batteries as a whole is also possible.

In quite particularly preferred developments of the present invention the secondary lithium-ion battery according to aspects of the invention contains two electrodes according to aspects of the invention, one of which contains as anode the composite material according to aspects of the invention containing doped or non-doped lithium titanium oxide, the other as cathode doped or non-doped lithium transition metal phosphate. Particularly preferred cathode/anode pairs are LiFePO₄//LiₓTi_{y}O with a single cell voltage of approx. 2.0 V, which is well suited as substitute for lead-acid cells or LiCo_{z}Mn_{y}FeₓPO₄//LiₓTi_{y}O (wherein x, y and z are as defined above) with increased cell voltage and improved energy density.

The invention is explained in, more detail below with the help of some examples which are not to be understood as limiting the scope of the present invention.

1. Measurement Methods

The BET surface area is measured according to DIN 66134.

The particle-size distribution was determined according to DIN 66133 by means of laser granulometry with a Malvern Mastersizer 2000.

The compressed density and the powder resistance were measured simultaneously with a Mitsubishi MCP-PD51 tablet press with a Loresta-GP MCP-T610 resistance meter, which are installed in a glovebox charged with nitrogen to exclude the potentially disruptive effects of oxygen and moisture. The tablet press was hydraulically operated via a manual Enerpac PN80-APJ hydraulic press (max. 10,000 psi/700 bar).

A 4-g sample was measured at the settings recommended by the manufacturer.

The powder resistance is then calculated according to the following equation:

Powder resistance [Ω/cm]=resistance [Ω]×thickness [cm]×RCF

The RCF value is equipment-dependent and was, according to the value settings of the manufacturer, given as 2.758.

The compressed density is calculated according to the following formula:

$$Compressed density ( g \text{/} {cm}^{3} ) = \frac{mass of the sample ( g )}{\prod \times {r}^{2} ( {cm}^{2} ) \times thickness of the sample ( in cm )}$$

$$r = radius of the sample tablet$$

Customary error tolerances are 3% at most.

### EXAMPLE 1

### Composite Material According to Aspects of the Invention Containing Lithium Iron Phosphate

283.4 kg of a fresh filter cake of lithium iron phosphate(187.6 dry weight with 66.2% solids content) produced by hydrothermal synthesis (according to CA 2,537,278), 9.84 kg lactose monohydrate corresponding to 52.5 g per kg lithium iron phosphate or approx. 1.1 wt.-% resulting pyrocarbon and 2.06 kg Timcal flake graphite SFG 6 corresponding to 1.1 wt.-% relative to the lithium iron phosphate was placed in a horizontal EMT 5501 ploughshare mixer with a cutter head. Then, 80 litres of deionized water were added via an internal spray head and mixing carried out over 15 min at a rotation speed of 140 RPM of the horizontal wave and 1500 RPM of the cutter head.

Overall there is a final carbon content of the total composite material of 2.2 wt.-%, wherein the weight ratio of particulate crystalline carbon to pyrocarbon is approx. 1:1.

The SFG 6 graphite used had a D₉₀ value of <16 μm. Alternatively, a so-called spherical graphite from the same manufacturer, Timcal KS, can also be used.

The D₉₀ value of the particles of the elementary carbon, whether graphite or carbon nanotubes or fullerenes or VGCF carbon, should preferably not be above 30 μm, preferably not above 25 μm and quite particularly preferably not above 18 μm.

The particles may have the form of fibres, flakes, spheres etc., without a geometric form being particularly preferred.

In order to prevent agglomerates, the slurry was then passed through a Probst & Class micronizer/cone mill and spray-dried in a Stork & Bowen dryer with atomizer nozzle at a gas entry temperature of 350° C. and an exit temperature of 125° C. at an atomization pressure of 6.0 bar. The dry product was then mechanically granulated. For this, an Alexanderwerk WP 50N/75 roller compactor was used at a roll pressure of 35 bar and a roll speed of 8 rpm and a feed device speed of 30 rpm. The compacted samples were granulated in a horizontal screen rotor mill with a 2.5 mm screen insert and separated from the dust portion on a vibrating screen with 0.6 mm mesh size.

The thus-obtained light-grey granules were then calcined under nitrogen in a gas-tight Linn chamber furnace under protective gas at a temperature of 750° C. and at a heating-up and holding time of 3 h each.

The granules, now black, were then ground on an Alpine AFG 200 grinder with 5.0 mm grinding nozzles at a grinding pressure of 2.5 bar.

### EXAMPLE 2

### Composite Material According to Aspects of the Invention Containing Lithium Titanium Oxide

100 kg of a commercially available grade EXM 1037 lithium titanium oxide from Phostech Lithium Inc. produced via solid-state synthesis, 3.0 kg lactose monohydrate corresponding to 30 g per kg lithium titanium oxide or approx. 1% of the resulting pyrocarbon and 1.0 kg Timcal flake graphite SFG 6 corresponding to 1.0 wt.-% relative to the lithium titanium oxide were introduced just as in Example 1 and further processed, wherein this time 300 l de-ionized water was sprayed onto the mixture in order to obtain a sprayable suspension with 25% solids content.

Overall the final carbon content of the finished composite material was approx. 2.0 wt.-% at a weight ratio of particulate crystalline carbon to pyrocarbon of approx. 1:1.

### COMPARISON EXAMPLE 1

As reference for the composite material according to aspects of the invention from Example 1 the lithium iron phosphate was treated as in Example 1, but
a) in the first variant mixed, without added graphite, with 105 g lactose monohydrate per kg lithium iron phosphate dry mass, with the result that the whole of the carbon content of 2.2 wt.-% resulting in the calcination is present as pyrocarbon.
b) in the second variant mixed, without added lactose, with 2.2 wt.-% SFG 6 graphite relative to the lithium iron phosphate dry mass, with the result that the whole of the carbon quantity of 2.2 wt.-% is present as particulate crystalline carbon.

### COMPARISON EXAMPLE 2

As reference for the composite material according to aspects of the invention from Example 2 the lithium titanium oxide was treated as in Example 1, but
a) in the first variant mixed, without added graphite, with 120 g lactose monohydrate per kg lithium titanium oxide dry mass, with the result that the whole of the carbon content of approx. 2.0 wt.-% resulting in the calcination is present as pyrocarbon.
b) in the second variant mixed, without added lactose, with 2.0 wt.-% SFG 6 graphite relative to the lithium titanium oxide dry mass, with the result that the whole of the carbon quantity of 2.0 wt.-% is present as particulate crystalline carbon.

The physical parameters of the composite materials according to aspects of the invention from Example 1 and 2 as well as of the comparison examples are shown in Table 1.

TABLE 1

| | | Ratio | | | | | Powder | Compressed |
|---|---|---|---|---|---|---|---|---|
| | Carbon | particulate/pyrolytic | d10 | d50 | d90 | BET | resistance | density |
| Example | [wt.-%] | carbon | [μm] | [μm] | [μm] | [m²/g] | (Ω/cm) | (g/cm³) |
| 1 | 2.2 | 1:1 | 0.19 | 0.43 | 2.11 | 11.5 | 32.7 | 2.34 |
| CE 1a | 2.2 | 0:1 | 0.19 | 0.41 | 2.33 | 12.5 | 24.6 | 2.13 |
| CE 1b | 2.2 | 1:0 | 0.20 | 0.40 | 1.13 | 8.8 | >>100 | 1.60 |
| 2 | 2.0 | 1:1 | 0.90 | 2.14 | 4.37 | 6.4 | 21.8 | 2.39 |
| CE 2a | 2.0 | 0:1 | 0.92 | 2.25 | 4.61 | 7.0 | 10.4 | 2.17 |
| CE 2b | 2.0 | 1:0 | 0.91 | 1.96 | 3.86 | 3.0 | >>100 | 2.13 |

As can be seen from Table 1, there is an increase of more than 10% in the compressed density.

### EXAMPLE 3

Measuring the density of the active material in an electrode

To measure the material density of the active material (i.e. of the composite material according to aspects of the invention) electrodes (thickness approx. 60 μm) composed of 90% active material, 5 wt.-% conductive carbon black and 5 wt.-% binder were produced.

For this

2.0 g 10% PVDF solution in NMP (N-methylpyrrolidone), 5.4 g NMP, 0.20 g Super P Li (Timcal) conductive carbon black, 3.6 g composite material according to aspects of the invention from Example 1 or comparison material from comparison example 1a were weighed into a 50-ml screw-lid jar and mixed for 5 minutes at 600 rpm, dispersed for 1 min with a Hielscher UP200S ultrasound finger and then, after adding 20 glass beads of 4 mm diameter and sealing the glass, rotated at a speed of 10 rpm on a roller table for at least 15 hours. To coat the electrode the thus-obtained homogeneous suspension was applied to an aluminium carrier foil with a Doctor-Blade laboratory coating knife with a 200-μm gap width and a rate of advance of 20 mm/sec. After drying at 80° C. in the vacuum drying cupboard, electrodes with a diameter of 13 mm were punched out of the foil and mechanically post-compacted at room temperature on a Specac uniaxial hydraulic laboratory press at a load of 10 t for 60 sec. To measure the density the net electrode weight was determined from the gross weight and the known unit weight of the carrier film and the net electrode thickness determined with a micrometer screw less the known thickness of the carrier film.

The active material density in g/cm³ in the electrode is calculated from

(active material portion in electrode formulation (90%)*electrode net weight in g/(n (0.65 cm)²*net electrode thickness in cm)

The resulting value for the active material density in the electrode was given as 2.00 g/cm for the comparison material from comparison example is and 2.17 g/cm for the composite material according to aspects of the invention from Example 1, producing an improvement of 8%.

1. A composite material, comprising one or more first particles, said first particles in part provided with a pyrocarbon coating comprising a mixed lithium metal oxide, said composite material further comprising one or more second particles, said second particles in part provided with a pyrocarbon layer comprising elementary carbon.

2. The composite material according to claim 1, wherein the mixed lithium metal oxide is a doped or non-doped lithium transition metal phosphate.

3. The composite material according to claim 2, wherein the transition metal is Fe, Co, Mn or Ni.

4. The composite material according to claim 3, wherein the transition metal is Fe.

5. The composite material according to claim 1, wherein the mixed lithium metal oxide is a doped or non-doped lithium titanium oxide.

6. The composite material according to claim 5, wherein the doped or non-doped lithium titanium oxide is lithium titanate Li₄Ti₅O₁₂.

7. The composite material according to 1, wherein the elementary carbon is a crystalline allotrope of carbon or VGCF carbon.

8. The composite material according to claim 7, wherein the crystalline allotrope of carbon is selected from graphite, carbon nanotubes, fullerenes as well as mixtures thereof.

9. The composite material according to claim 1, wherein the layer thickness of the pyrocarbon coating lies in the range of from 2 to 5 nm.

10. The composite material according to claim 9, wherein the pyrocarbon coating on the mixed lithium metal oxide particles and/or the elementary carbon particles covers the entire surface of these particles.

11. The composite material according to claim 1, of which the particle size D₉₀ is ≦2.15.

12. The composite material according to claim 1, the BET surface area of which is ≦12 m²/g.

13. The composite material according to 1, the compressed density of which is >2.0 g/cm³.

14. The composite material according to claim 13, wherein the compressed density lies in a range of from 2.0 to 3.3 g/cm³.

15. The composite material according to claim 1, the powder resistance of which is <35 Ω/cm.

16. The composite material according to claim 1, the total carbon content of which is <3 wt.-% relative to the total weight of the composite material.

17. The process for producing a composite material according to claim 1, comprising the steps of
a) providing a mixed lithium metal oxide
b) adding i) a precursor compound of pyrocarbon as well as ii) elementary carbon and producing a mixture
c) compacting the mixture from step b)
d) heating the compacted mixture.

18. The process according to claim 17, wherein a doped or non-doped lithium transition metal phosphate is used as mixed lithium metal oxide.

19. The process according to claim 17, wherein a doped or non-doped lithium titanium oxide is used as mixed lithium metal oxide.

20. The process according to claim 17, wherein a carbohydrate is used as precursor compound of pyrocarbon.

21. The process according to claim 20, wherein in step b) an aqueous mixture is produced in the form of a slurry.

22. The process according to claim 21, wherein the slurry is dried before step c).

23. The process according to claim 17, wherein the heating in step d) takes place at a temperature ≦750° C.

24. The process according to claim 23, wherein the heating takes place under a protective gas atmosphere.

25. The process according to claim 23, wherein after heating the obtained product is ground.

26. The electrode for a secondary lithium-ion battery containing as active material the composite material according to claim 1.

27. The electrode according to claim 26 containing 80 to 90 parts by weight active material, 10 to 5 parts by weight conductive carbon and 10 to 5 parts by weight binder.

28. The electrode according to claim 26, wherein the density of the active material of the electrode is >1.9 g/cm³.

29. The electrode according to claim 26, wherein the composite material contains a doped or non-doped lithium transition metal phosphate.

30. The electrode according to claim 26, wherein the composite material contains a doped or non-doped lithium titanium oxide.

31. The secondary lithium-ion battery comprising an electrode according to claim 26.

32. A secondary lithium-ion battery, comprising as cathode an electrode comprising as active material a composite material, said composite material comprising one or more first particles, said first particles in part provided with a pyrocarbon coating comprising a mixed lithium metal oxide, said composite material further comprising one or more second particles, said second particles in part provided with a pyrocarbon layer comprising elementary carbon, and said composite material further comprising a doped or non-doped lithium transition metal phosphate, said battery further comprising as anode an electrode comprising as active material a composite material, said composite material comprising one or more first particles, said first particles in part provided with a pyrocarbon coating comprising a mixed lithium metal oxide, said composite material further comprising one or more second particles, said second particles in part provided with a pyrocarbon layer comprising elementary carbon, and said composite material further comprising a doped or non-doped lithium titanium oxide.
